(19) United States
(12) Patent Application Publication
(10) Pub. No.: US 2011/0066526 A1
(43) Pub. Date: Mar. 17, 2011

(54) System and Method For Electronic Publication and Fund Raising

(76) Inventor: Tom Watson, Chicago, IL (US)

(21) Appl. No.: 12/560,109

(22) Filed: Sep. 15, 2009

(51) Int. Cl. G06Q 50/00; G06Q 10/00; G06Q 30/00; G06Q 20/00

(52) U.S. Cl. 705/27.2; 705/310; 705/329

(57) ABSTRACT

The invention provides a system and method for electronic publication of original, creative works on a website as well as systems and methods for compensating the author(s) of the original creative works. The electronic publishing systems of the present invention can also be utilized in novel methods of fund raising for charitable and/or non-profit organizations.

### FIELD OF INVENTION

This invention relates generally to a system and method of electronic publication of multiple authors' original works in a book style format on a World Wide Website as well as methods of charging customers for accessing one or more of the works and compensating the authors of such original works.

### BACKGROUND OF THE INVENTION

There are currently in existence a number of electronic publication systems such as TumbleBooks. The Tumblebooks website is an enhanced electronic library in which existing hard copy works (ink and paper books) are available for reading online in an electronic format. The Tumblebooks website is designed primarily to assist young people to learn to read by providing recorded audio of a narrator reading highlighted text as it is displayed on screen to the student. In other words, the student practices reading by listening to the audio recording of the displayed text while simultaneously reading the text as it is highlighted on the screen. Once the basic skills of reading are acquired by a child, the primary purpose of Tumblebooks website is to provide a library of books which assist older students in improving their reading skills by continuing the same basic process with more challenging materials. While the website appears to be well suited to assisting students in first learning and then improving their reading skills, the Tumblebooks website is not designed to assist students or novice authors in acquiring writing skills, writing stories for later publication, or publishing student works.

The process of publishing paper and ink versions of books is sufficiently capital intensive that it has become extremely difficult for young or novice authors and illustrators to get their works commercially published. Under the current circumstances, it is quite difficult for even experienced, adult authors to attract a commercial publisher that will take on the business risk of producing and distributing costly paper and ink copies of their works. In fact, as of the time of the filing of this application, the commercial publishing industry rejects about 99% of all works submitted to it. Another unfortunate result of the high capital costs and business risks involved in the traditional commercial publishing trade is that its editors often select homogenous, low-risk, commercial projects for publication, particularly familiar book series, at the expense of more creative and adventurous works of potential greater artistic merit. These business risks also tend to skew the editors at commercial publishers toward the works of well-established authors at the expense of younger, inexperienced and/or unpublished authors. Another drawback with traditional ink and paper commercial publishing is that, even when an author beats the odds and gets one of their works commercially published, the process is very slow moving often taking more than two years from submission of a new work to the actual retail distribution as a book.

Some authors have responded to the entrance barriers and delays inherent in traditional paper and ink commercial publishing industry by attempting to self publish their works. However, this avenue to commercial publication has proven disappointing to most authors because they have had difficulty raising sufficient capital to pay for large print runs for their works and, even if they are able to raise such funds, it is often difficult to secure sufficient distribution and marketing reach for such works to justify the expenditure. To date, applicant is not aware of any self-published works that have been able to reach the mass market of potential readers that commercial publishers frequently reach with their more successful publications.

### OBJECTS OF THE INVENTION

Accordingly, an object of the invention is to provide a system and method for efficient low-cost electronic publication of works of authorship by young authors, novice authors, young illustrators, novice illustrators, students and/or other unpublished or published authors.

Another object of the invention is to provide financial incentives for such young, novice, unpublished or even experienced authors and illustrators to create original works for publication in electronic format with wide public distribution.

A further objective is to promote group authorship of a work to publish in a systems and methods of non-profit fund raising, which will primarily be utilized by school-based groups, although other non-profit groups could also do so.

A still further object of the invention is to drive awareness of the electronic publisher's website with educators and their students by promoting school-based collective publishing as a means for non-profit fund raising for schools, school projects or other charitable purposes.

An even further object of the invention is to provide a system and method for efficient low-cost electronic publication of works of authorship, which allows an electronic publisher to pay a significantly higher percentage of the purchase price of the original creative work to its author and/or illustrator than is possible for traditional paper and ink commercial publishing.

An additional object of the invention is to significantly increase the speed with which an original creative work is published to the benefit and enjoyment of the reading public and to enable the author and illustrator to receive the compensation due them from purchase of their original creative works far more quickly.

Another object of the invention is to provide a system and method to encourage the publication of more diverse, less homogenous creative works, which would have remained unpublished by traditional, ink and paper commercial publishers.

### BRIEF SUMMARY OF THE INVENTION

One embodiment of the invention provides an electronic publishing method which includes the steps of soliciting original creative works for publication through an electronic communication system, such as the World Wide Web. The creator of the work can upload the text and/or images of the work(s) onto the web site. Next, the contributions are screened for meeting the electronic publisher's internal quality standard prior to electronic publication on the website. Works or contributions that meet those quality standards are approved for publication. Then, the creators of the accepted contributions are contacted by the electronic publisher and provided with a publication agreement setting forth the terms and conditions of the electronic publication. The publication agreement preferably includes a limited number of creator compensation options for selection by the creator, such as allowing viewing and/or reproduction of the work free of charge, for a small sum of money, or in exchange for a donation to a non-profit or charitable organization. Along with the agreement, the creator of the work may be asked for information necessary to create a profile of the work and/or the author, which may include a description of the subject matter of the work, the reading level of the book, the age group the creator has targeted as the audience for the work, and any searchable key words concerning the work that seem appropriate to the author. Upon receipt of the executed publication agreement from the creator, the electronic publisher then allows access to the original work to the patrons of the website, subject to the compensation option selected by the creator. Preferably, at this same time, the electronic publisher adds the creator-supplied indexing data for the original work to the appropriate publication database(s) for the website. The patron may browse for publications on the website that are pay for view, pay per download, free for on-line viewing (or pre-viewing), free for downloads, free for printing, pay for printing, as well as donation to a non-profit organization per view and/or download. Optionally, the creator(s) of a work may elect to donate some portion or the entire compensation due the creator to a fund-raising effort by a charitable or non-profit organization.

By utilizing the preferred methods and systems of invention to electronically publish original works, the electronic publisher can significantly cut the cost of publication per work so that far more works can be published than are feasible for a traditional ink and paper commercial publisher. Moreover, the time from submission to publication can also be significantly reduced, and the electronic publisher can afford to charge a lower purchase price for works published on the website, while still paying a significantly higher percentage of that price to its author and/or illustrator. As the electronic publisher's financial risks with regard to each individual work is significantly diminished, the editors of the electronic publishing systems can select for publication a far more diverse group of works and encourage less conventional approaches by the authors and illustrators and can also establish standards designed to ensure that a significant percentage of the works selected for publication have been authored by young authors and illustrators. In this way, the editors of the electronic publisher can encourage creative expression by a more diverse group of authors than is currently being served by traditional commercial publishers.

In another method of the invention is to identify unpublished authors and to provide financial incentives to motivate such authors to create original creative works, which includes the steps of soliciting from unpublished authors original, creative works for electronic publication in book form through a website operated by an electronic publisher. The electronic publisher then selects from the submitted original creative works of the unpublished authors at least a majority of the works for electronic publication on the website in book form. As the cost of such electronic publication is significantly lower than for paper and ink publication, the electronic publisher is not nearly as constrained by the capital requirement for publication. Accordingly, in one preferred method of the invention, as many as 75% of the original creative works submitted by the unpublished authors can be accepted for electronic publication. Next, the electronic publisher provides the unpublished authors with a limited menu of compensation options for allowing electronic access to the original works on the website by purchasers. After the electronic publisher receives the returned agreement, the original work is published on the website subject to the compensation option selected by the unpublished author. The electronic publisher provides means on its website for patrons (or purchasers) to select one or more of the electronically published original works of the unpublished authors in order to access the works. The electronic publisher collects access fees (or a purchase price) from website patrons in accordance with the compensation option selected by the unpublished author for each of the works. The electronic publisher then makes the original works accessible to the website patron. Preferably, this will include at least the following options for the patron to select: (1) viewing the original work on the patron's display, (2) downloading the original work to the patron's digital storage medium, or (3) printing the original work on the printer associated with the patron's computer. Lastly, the electronic publisher remits the portion of the access fees collected from the website patrons in accordance with the compensation option selected by each of the unpublished authors. Preferably these funds due an unpublished author will be allowed to accrued for a reasonable period of time, e.g., for one quarter and the unpublished author will be sent quarterly payments with a statement reflecting the number of times the author's original works were accessed in a given payment accrual period.

In another method of the invention a non-profit fund raising system and method is provided through electronic publication of an original collective creative work. The system and method include the steps of soliciting original, collective creative works for electronic publication in book form through a website operated by an electronic publisher in order to generate funds for at least one charitable or non-profit organization selected by one or more of the collective authors. Then, one or more of the collective authors will upload the original creative work to the website for potential electronic publication thereon by the electronic publisher. Next, the electronic publisher will screen the uploaded original, collective work for meeting the publisher's minimum quality standards. Those original, creative collective works that meet the minimum quality standards of the electronic publisher are approved by the electronic publisher. The electronic publisher provides the collective authors with a menu of compensation options offered for the electronic publication of the original, collective work, which includes remittance of a percentage of the funds collected for access to the original, collective work to at least one of the designated charitable or non-profit organizations. Upon electronic publication of the original, collective work, the electronic publisher activates means for website patrons to access one or more of the electronically published, collective, original works of the collective authors in order for the patron to access the original, collective work, subject to the compensation option selected by one or more of the collective authors. The electronic publisher collects the fees from website patrons for access to the collective, original work in accordance with the compensation option selected by the collective authors. Then, the electronic publisher remits at least a portion of the fees collected from the website patrons in accordance with the compensation option selected by the collective authors to at least one of the designated charitable or non-profit organizations. In most cases, it is contemplated that such fund-raising projects will be organized and administrated by classroom teachers of school-age children. Such collective works are most likely to be authored and illustrated by the school children and donations are most likely to be solicited from relatives and friends of the school-aged authors and illustrators. An added benefit of this fund-raising approach is that it is an efficient way to increase the brand awareness concerning the electronic publisher's website in important target markets, i.e., student and teachers, while at the same time assisting them in raising funds to the benefit of the general public.

### BRIEF DESCRIPTION OF THE DRAWINGS

FIG. 1 is a page view of an electronically published flashbook in accordance with one embodiment of the systems and methods of the invention;

FIG. 2 is a block diagram illustrating the computer network utilized in accordance with one embodiment of the invention;

FIG. 3 is a summary flow diagram illustrating a flashbook creation process in accordance with the electronic publication systems and methods of the invention.

FIG. 4 is a summary flow diagram illustrating an editorial review process in accordance with the electronic publication system and methods of the invention.

FIG. 5 is a summary flow diagram illustrating the process of purchasing access to the electronically published work in accordance with the systems and methods of the invention.

FIG. 6 is a summary flow diagram illustrating a process of paying creators or others to whom payment is due on a new work published electronically in accordance with the systems and methods of the invention.

### DETAILED DESCRIPTION OF THE PREFERRED EMBODIMENTS

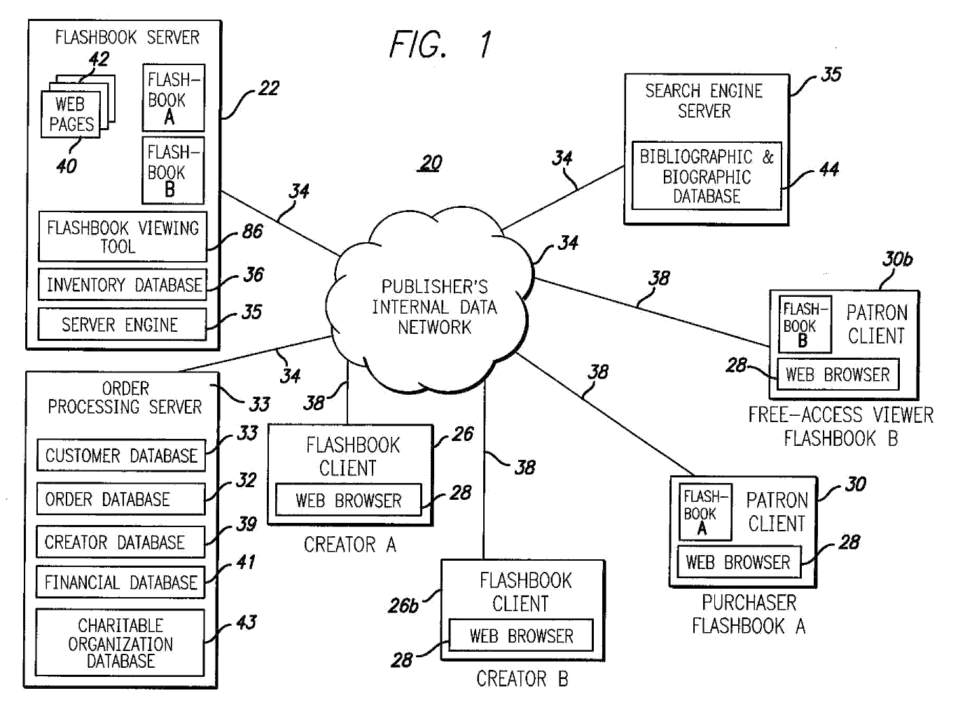

The systems and methods of the invention include the electronic publication of page-turnable Web books 23 (“flashbook”) on a web server based system shown in the illustrated system 20 of FIG. 1. An alternate flashbook server architecture is shown in FIG. 20a, in which separate servers have been consolidated. Web server computers that support one or more flashbooks are called flashbook servers. Flashbook server 22 is interconnected with flashbook creator's client computer 26, as well as flashbook purchaser's client computer 30 via data network 34. Also connected to data network 34 is search engine server 356. Data network 34 is preferably a packet-based data network such as an intranet (i.e., a local area network (LAN) or wide area network (WAN) using Internet protocols). Communication paths 38 are modem lines or LAN or WAN network connections, preferably providing connections with multiple client computers via the internet. The server is connected to a web-hosting service that maintains a website where patrons can access the flashbooks submitted as original works of creative expression by authors, illustrators or other contributors (collectively, creators) of creative expression contained in a flashbook.

A creator at client computer 26 contributes an original work of authorship for publication as flashbook, such as original work A on client computer 26. The contributed material can be any content supported by the book display software, resident on the flashbook server, such as, e.g., text, illustrations, and even audio or video information. The contributed material will typically be literary or artistic in nature, such as illustrated children's stories, short stories for older children, and novels or longer format stories for teens and adult, etc. A flashbook may contain a number of different types of contributions, such as story text and illustrations, but may also include songs, or short video clips, structured around a central theme. If desired, flashbooks may be set up to support more limited types of media and more focused formats.

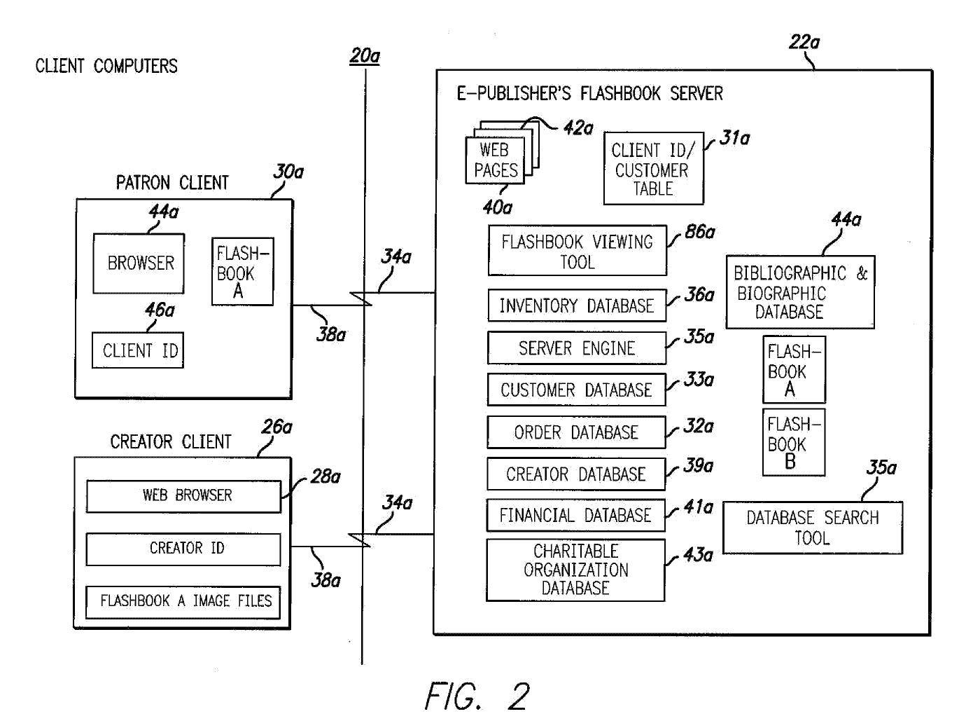

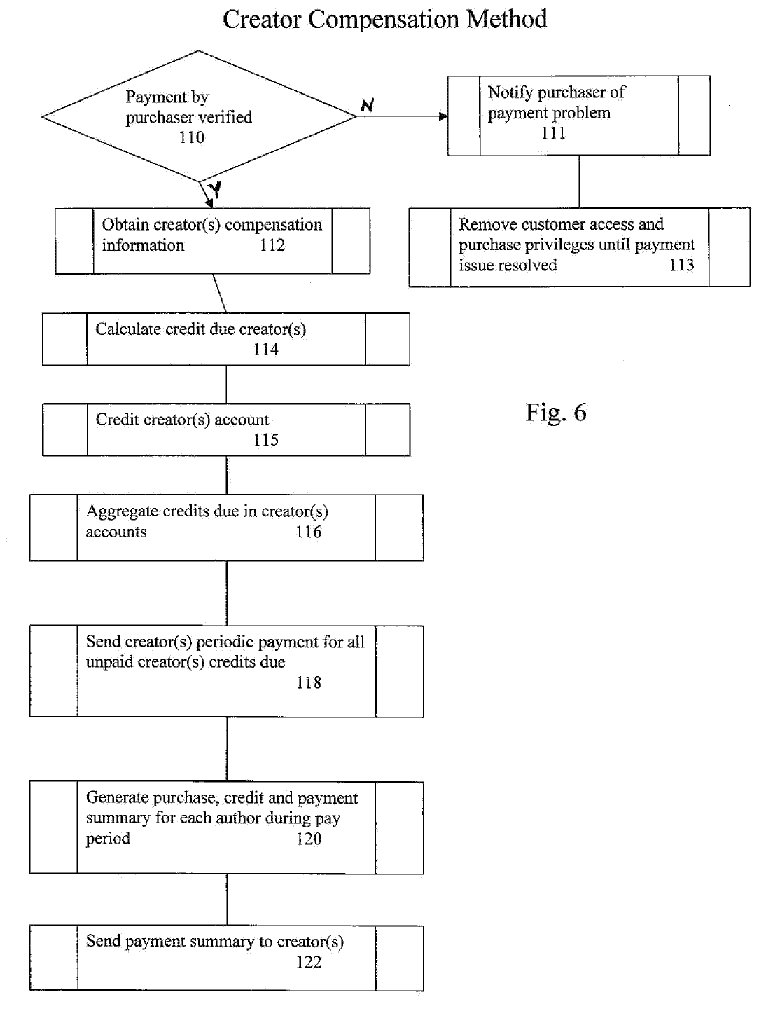

A viewer at flashbook purchaser's client computer 30 can preferably preview the material contributed to a flashbook without first purchasing a particular flashbook. “Viewing” (by purchaser) includes reading, listening, and observing any type of contributed material that is contained in a flashbook. While it is contemplated that most purchases of the electronic publications in book form will be via an on-line internet connection from a computer, it is contemplated that the purchaser may access the works via hand-held devices such as smart phones, PDA, or other communication devices with a display, internet access, and sufficient data storage to download one or more of the flashbooks 23. Presentation of flashbook material for viewing may involve the execution of computer code associated with or contained in that material. Contributed material is preferably stored on the publisher's flashbook server 22 in the form of flashbook web pages 42, as shown in FIG. 2. Web pages 42 may contain both static Web pages and Web pages with content that changes dynamically whenever referenced. Web pages 42 include welcome message page 140 to introduce a user to the flashbook. If desired, welcome message page 40 can include summary information concerning the content of flashbook web pages 42. For example, welcome message page 40 can include information regarding the author(s)/illustrator(s) who have contributed material, a description of the theme of the flashbook, the specific subject matter contained in the flashbook, the media used, etc. In one preferred embodiment of the system, potential purchasers that are previewing a work are blocked from proceeding past a welcome page 40 without first purchasing the flashbook. After viewing the welcome message page 40 and completing an appropriate purchase process, users can view, download or print the flashbook using flashbook viewing tool 86 to do so as explained in more detail below with reference to FIG. 6. While many of the flashbooks available at the publisher's website will be pay-for-access only, it is also intended that free access flashbook, such as flashbook B, will also be available for viewing and downloading as shown with reference to client computer 30b in FIG. 1.

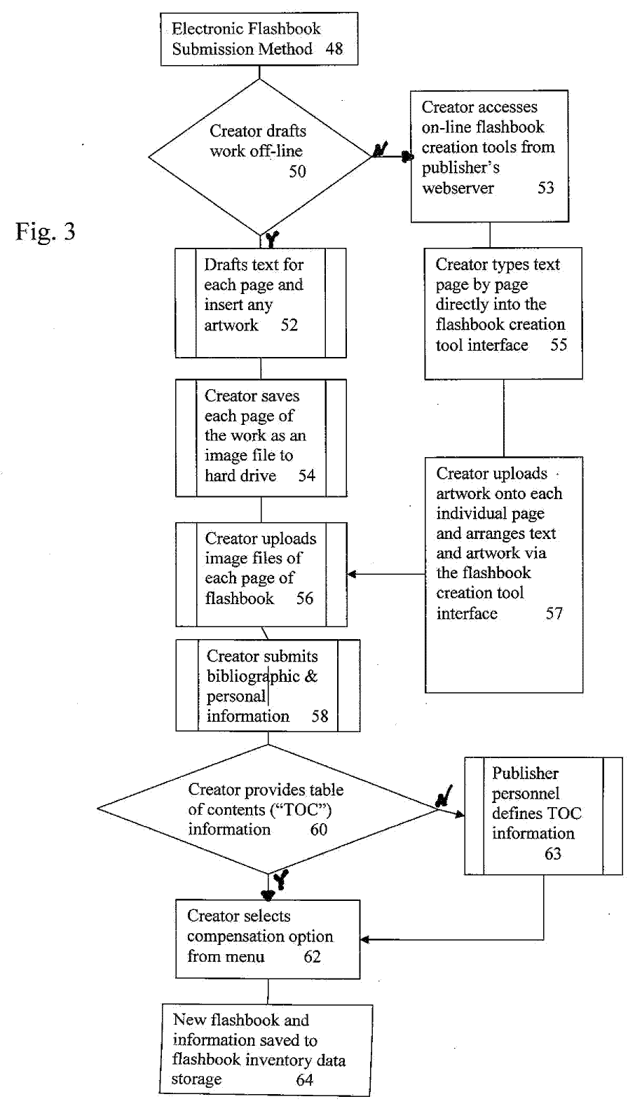

The preferred flashbook viewing software is FlippingBook HTML Edition by Media Interactive, S.A, although other web page display or media viewer software can be utilized in the methods of the invention. When an author submits a new work for publication, the author can either submit the work as suitable image files or may create the work on-line directly into the flashbook authorizing viewing software. As illustrated in summary fashion in FIG. 3, due to the complexity and time consuming nature of the authorship and submission processes, it is contemplated that most authors will elect to complete their works off-line, by writing the text and images on each page (step 52), saving those pages of their work (step 54) to their own computer storage media as image files on the client's computer 26, then uploading those files (step 56) to the publisher's website. Then the publisher's personnel will convert those image files for flashbook viewing, and to store the flashbook on the digital storage media 36 of the Flashbook Server 22 electronic publisher. In most cases, the process of converting a new work submitted as image files can be delayed until the publisher has received an executed publication agreement from the creator, but may be undertaken immediately upon submission by the creator.

Whether it is performed on-line or off-line, the flash book creation process is performed in several steps, which include: (a) preparing book pages, (b) copying files, (c) configuring book parameters, and (d) publishing the book on the web server. As mentioned above, the author will typically create his work off-line and save each page of the work as an image file in one of the preferred formats JPEG, PNG, or SWF file. The publisher's website will include a web page 42 instructing potential authors about their options for submissions of new works. Since the preferred publishing software stores each page of the author's work as a separate image file, the author is informed that it is best to create image file pages, which include both images and text in the precise arrangement that the author/illustrator would like them to appear in the finished product. Once the work is completed off-line, the pages of the work are uploaded as image files to the inventory database 36 of the flashbook server 22 of the electronic publisher.

As is shown in the summary flowchart of FIG. 3, the process of transforming the work to a functional flash book is either performed by the website personnel after the author uploads the image files or is created on-line in the flashbook form by taking the creator through a menu-driven work-creation interface, which guides the creator through the steps set forth below. The menu driven process of creation requires that the creator of the work selects the online flash book creation tool (step 53) using the creator's Web browser 28 on the flash book publisher's website. The creator then types (step 55) in the text of the book and then uploads the artwork for each individual page and then precisely arranges the text and art work (step 57) as they should appear in the flash book viewer. For each work, a separate directory or folder on either the flashbook server 22, or optionally, on digital storage media linked to the flashbook server 22 such as inventory database 36 is created either by the website personnel or automatically when a user selects the on-line interface menu. The new folder or directory containing the new work is flagged as inactive by the personnel or system automatically in the menu-driven scenario since the author of the work has not yet executed the electronic publisher's publication agreement. The electronic publisher's website software then prompts the creator to submit bibliographic information (step 58) concerning the new work, and optimally, personal information concerning the author(s) or illustrator(s). That bibliographic and/or personal information is stored along with the image files in the new folder or directory created for the new work. The personal information may include the following: the creator's name, street address, e-mail address, age, gender, and level of experience in the field of the work (e.g., novice author or illustrator, experienced but unpublished author or illustrator, professional published author or illustrator, etc.). The bibliographic information collected by the electronic publisher preferably includes information concerning the original work, such as, the general subject matter of the original work, a brief description of the original work, key words, the reading level of the work, the age group of the target audience, and a suggested portion of the work to publish as a free preview. Optionally, the creator may include a short biography as well as a headshot photograph for electronic publication on the website. As no work will be published by electronic publisher without the creator executing a suitable publishing agreement, the identity of the creator and their address (either e-mail of street address) will be required information so that the electronic publisher can forward a copy of a suitable agreement for execution by the creator. If the creator has created a work which includes multiple chapters, the creator is prompted by the publishing website software to provide table of contents information (60), which defines where each chapter of the new work begins. Where the creator fails to submit such information, the publisher's personnel can alternately define the page numbers to include in the table of contents (63). The website software next preferably generates an inactive status flag associated with the new work which is communicated to the electronic publisher's staff to prompt them to review for the new work.

Turning in more detail to the process of configuring the flash book viewing software for new work, the flashbook viewer tool defines the flashbook size that is displayed on-line in the number of pixels equal to the display of two book pages of a new work. The zooming function is often beneficial when the illustrations for the work include fine detail, which are easier to view in an enlarged image on the page. Preferably, the flashbook view software stored in the flashbook server 22 is set to be enabled to allow close-up views of an author's (or illustrator's) work. However, that “zoom enabled” default setting can be altered by the creator or by the publisher's personnel on a book by book basis.

Preferably, the pages of the book are processed on a page-by-page basis in a JPEG image format. If the image files are submitted in a format other than JPEG, they can be converted to JPEG format with any of a number of commercially available image file converters, such as, Swiftoos.

After the pages have been converted to an appropriate image file format, then the next step is to configure a HTML page (web page) corresponding to every two pages of the flash book, that is, the image files for each pair of facing pages of the book. To be able to work with the book to be published, the electronic publisher utilizes the FlippingBook.swf file of the FlippingBooks software viewing package, which contains the flash application of the book and will preferably be stored in inventory database 36 (or 36a) of the electronic publisher's flashbook server 22 or (22a). The flash publication software's Js/ folder will typically be loaded into flashbook viewing tool, and it will contain the JavaScript files necessary for creating the work. Similarly, the flashbook viewer's css folder/ contains the css file styles necessary for creating the work. The flash viewers img folder/, contains button and application background images needed for the book. Its index.html file includes an example of the liquid template for the new book. The electronic publisher will typically elect to use one or more standardized liquid HTML chosen to be age and subject matter appropriate for each new work. But, publisher also will, for a particular work, allow authors to create their own custom HTML templates to customize the look of the displayed pages in the flashbook viewer for their own work. After the HTML template files are completed and all the necessary files are copied and ready for the new work, the next step is to configure the book interface.

The flashbook Interface includes about 60 different publication parameters that may be custom configured for each web page of an individual new work. However, it is contemplated that the electronic publisher will select from a limited number of stock custom templates of such parameters for different styles of publications. It is further contemplated that the electronic publisher may allow the creator to choose from one or more of the available templates or to customize one or more of the viewing parameters.

All the book settings for a given book interface template are specified and stored inside the book Settings.js file and saved along with the flashbook to inventory database 36. In total, the flashbook viewing software includes more than 60 different parameters for flashbook display but most new works will utilize a standard package of display parameters. Every parameter has the default value specified in the flippingBook.js file and if the default values are acceptable, there is no need to configure the bookSettings.js file. For example, in one of the stock flashbook parameter templates, the default value of the hardcover parameter is false (switched off). If this suits the creator of the work, the author can select the “no hardcover template” of parameter settings. If, on the other hand, the creator wants the published flashbook to show a hardcover, the following command string is added to the book Settings.js file: flippingBook.settings.hardcover=true:. All of the other 60 parameters are configured in a similar manner, e.g., flippingBook.settings.parameterName=parameterValue:

To configure individual pages of the flashbook, the first step is to specify the path to the page files in the bookSettings.js file. For example, flippingBook.pages=[“pages/page-001.jpeg”, pages/page-002.jpeg“,]; can use either relative (folderName/fileName) or absolute paths: http://www.site.com/some-folder/some-file.jpg for doing so. Then, parameter settings for each page may be modified in a manner similar to that described above.

To configure the table of contents for a new flashbook, first specify a chapter name and page number, for the beginning of each, for example: flippingBook.contents=[[“Cover”, 1], [“Modern”, 4], [“Familiar”, 34], and [“Classic”, 58]]. In this example, the “Modern” chapter starts with page 4 and ends at page 34.

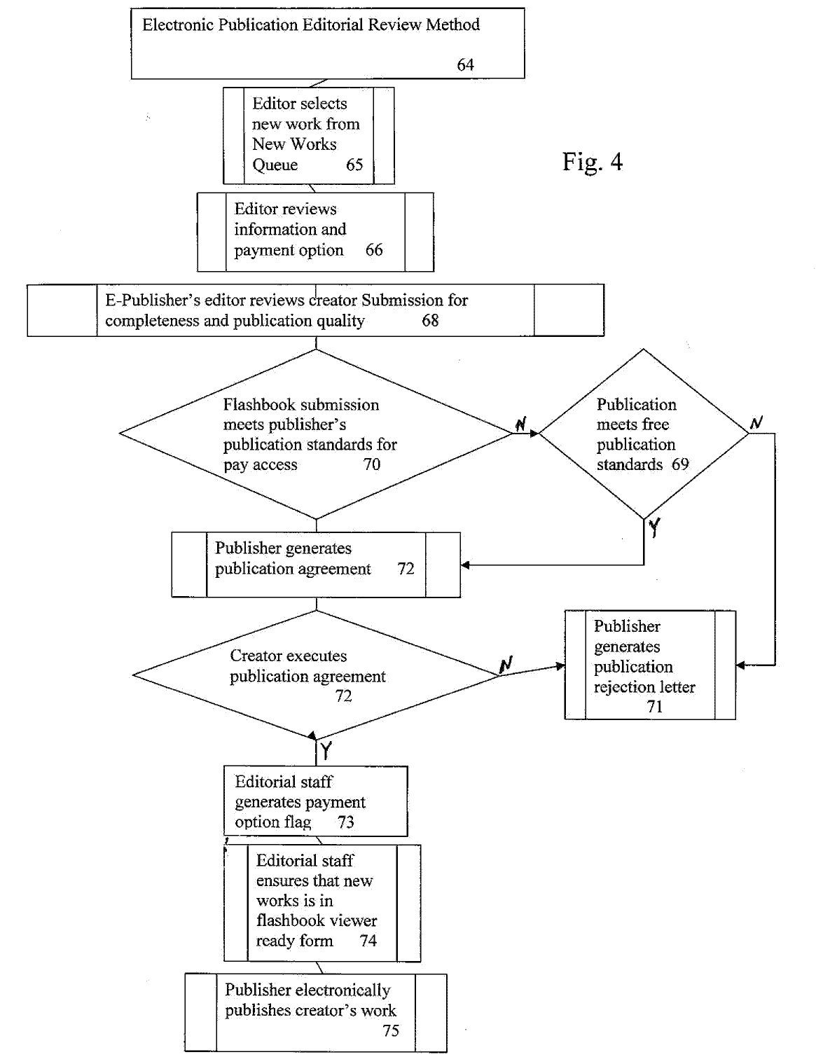

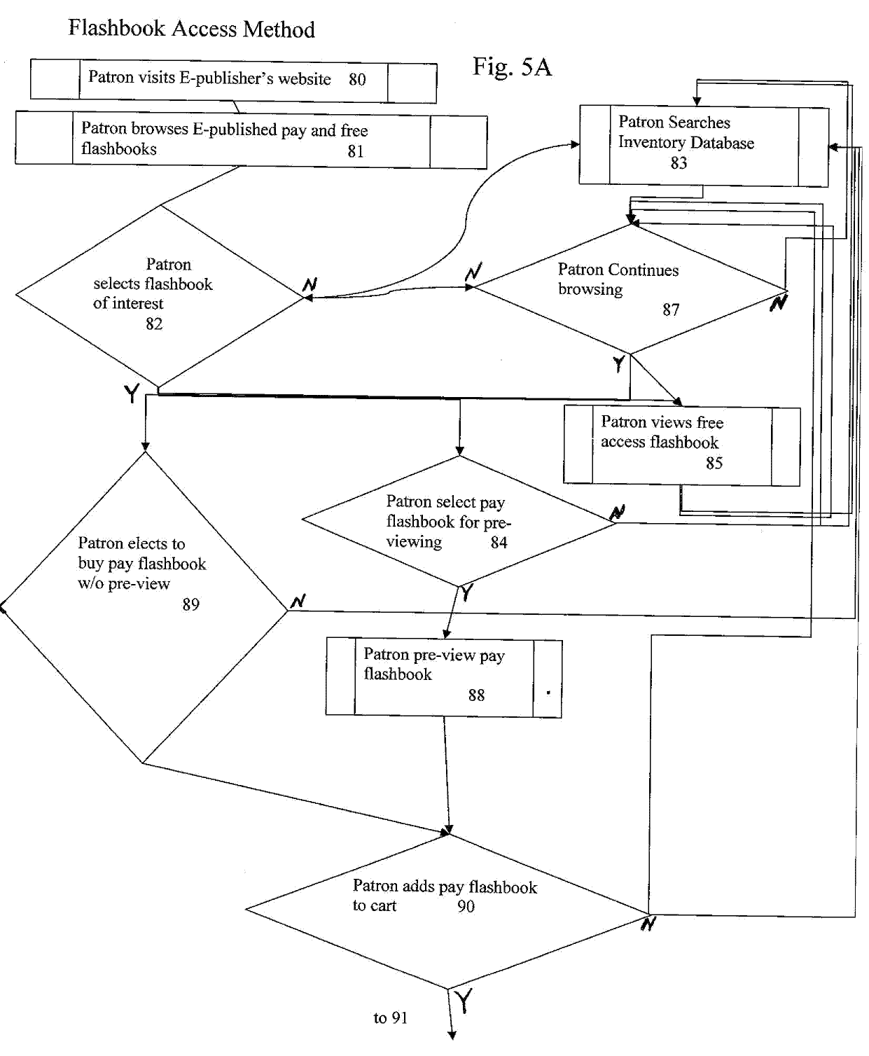

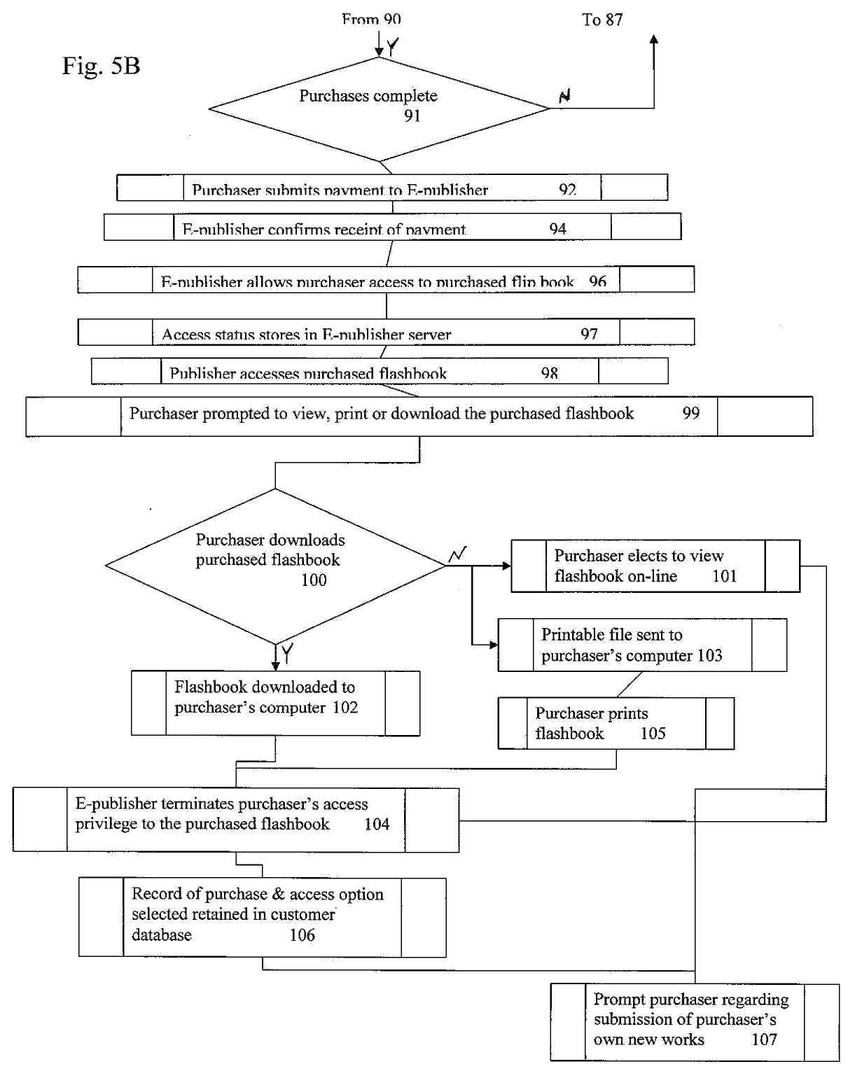

The website software is programmed to prompt the creator to choose one of the pre-defined number of compensation options (step 62, see FIG. 4) from a predefined menu of options provided by the publisher. Preferably, those compensation options include at least pay-for-access, charitable donation for access and free access to the creator's electronically published new work A or B as shown in FIG. 4. In order to prepare for editorial review of freshly submitted flashbooks, the images files and associated creator information, including the selected compensation option are uploaded to the inventory database 36 on the electronic publisher's server 22 and saved in a new work directory or file (step 64) for editorial review. The electronic publisher will not publish any new work without it first undergoing an editorial review by the electronic publisher's staff. However, it is one important object of the invention to speed the editorial review process such that the creator of a newly submitted work will receive at least some initial feedback from the electronic publisher within two weeks of submission. To assist in achieving that goal, the date of submission will be saved along with the new work in an inventory database, and preferably, the website software will calculate a goal creator feedback date and forward an electronic message to the editorial staff providing that goal date, as well as save that date to the editorial staff master calendar database. It is also preferable that the server is programmed to collect each of the electronic editorial review request messages concerning each new work and to save those messages in the inventory database 36 in order to create a new work editorial review queue (step 61). If a new work is approved for publication during the editorial review, an appropriate publication agreement is generated and delivered to the creator of the work whether it be an author or illustrator.

One significant reason that the electronic publishing systems and methods of the invention allow for rapid electronic publication are the efficiencies resulting from requiring creators to submit their works as either (a) image files with text and art work already laid out in the author's preferred configuration or (b) creating the work online directly into the menu driven flashbook creation software interface provided on the publisher's website. In either case, the author/artist creates the pages with the text and images arranged just as the creator prefers that they will appear in the flashbook viewer provided to the electronic publisher's patrons. In traditional paper and ink publishing, the text is usually submitted separate from the images or artwork and then these separate parts are married together. This means that the publisher's editorial and artistic staff is involved in the page set up and lay out processes, which typically means multiple approvals and revisions of the proposed layouts of the book by both the creator and the editorial staff. Such processes can become quite time consuming, particularly when both the author/artist(s) and editorial staff are all working simultaneously on other high priority projects. Further, most pen and ink publishers also must take photographs or high resolution scans of the art work in order to provide the printing house with reproducible drawings or illustrations for a work, which are then typically adjusted or ‘touched up’ to provide the exact color and illustrative specifications desired by the publisher. These are additional steps that can slow down the process of traditional publishing. By requiring submission in electronic formats that are easily converted to flashbooks, the process of electronic publishing can be greatly sped up. The demands and specifications of the end-product flashbook are much easier to meet—and the creator essentially meets them all before final submission. This not only speeds the process greatly, but also allows the choice of the final product's appearance to derive from the creator, not the publisher—an uncommon occurrence in the traditional ink and paper publishing tradition. Further, the use of a page-turning style, flashbook viewer, provides the website patron with an on-line experience that has a similar feel to turning the pages of a traditional pen and ink book. This is because the pages are arranged side-by-side and are preferably capable of being turned through interaction with the viewing software provider by the electronic publisher.

FIG. 4 provides a flowchart style summary of the editorial review processes in accordance with one embodiment of the invention. The electronic publisher's editorial review processes are an important component of the new electronic publication systems and methods of the invention. Typically, the process would begin by the editor selecting a new work from the new work editorial review queue 61 (step 65). Next, the editor makes an initial screen (step 66) of the creator's personal information as well as information concerning the compensation option selected by the creator. This is done, in part, because the electronic publisher intends that the published pay-for-access or donation for access works will typically meet significantly higher editorial quality standards than the free access works. For creators that wish to publish their works in exchange for monetary compensation, the editors will first ensure that the creator's work meets its internal publications standards in order to maintain the commercial reputation of the electronic publisher's website with the potential purchasers of its pay works. The publication standards for the electronic publisher completely invert the traditional model of a commercial publisher, in that, the goal is to encourage the generation of original creative works by publishing high percentages of the creative works submitted. The economics of the traditional commercial publishing model require rejection of the vast majority of submissions due to the costs involved in printing, distribution and marketing of the few works selected for publication. In contrast, the electronic publisher will publish at least 50% of the original works submitted, and preferably more than 75% of those works, so that authors and illustrators are encouraged to write and illustrate in new and creative ways. As another of the goals of the electronic publisher is to increase the supply of original creative works for the reading public to enjoy, the inclusive editorial policy of the electronic publisher will also help to further this goal. A related goal of the electronic publisher is to provide the public with an additional supply of new, high quality works of creative expression at a price that is sufficiently affordable to encourage additional purchasing and reading by children, adolescents and young adults of such works. In order to meet this goal of providing affordable works and to ensure that creators are encouraged to create new works, the electronic publisher policy will charge relatively modest sums for the electronic publications (when compared to traditional publishers), while at the same time paying at least 50% of the funds collected for the pay to access original works to the creator(s) of the work. In practice, this means that electronic works may retail for as little as $1.99, while a comparable paper and ink children's book would seldom retail for less than $10.00. The electronic publisher's creator compensation model is, again, in stark contrast to the traditional commercial publication model, in which, even highly successful authors typically receive royalties for sales of their works of less than 10% of gross sales dollars.

For the reasons discussed immediately above, the electronic publisher's publications standards can be far more inclusive than those of traditional commercial publishers. However, it is another important goal of the electronic publisher to encourage young, novice and unpublished authors and illustrators to create original stories and illustrations. Accordingly, the electronic publishers will also give high priority to identifying all submitted original works of young, novice and unpublished authors and illustrators that are believed of sufficient quality or creativity to merit selection for pay-for-access publication. As the fees for access to such works may often be relatively modest (in keeping with the electronic publisher's goals of providing affordable new works to the public), the financial incentives may in some cases prove to be relatively modest for young authors and illustrators. However, when contrasted with the current state of commercial publishing, in which such works remain unpublished with no hope of compensation, such modest compensation is considerably more attractive. In addition, a modest sum paid to a young creator may seem to them to be truly significant—for instance, selling roughly 20 books to friends and family could equal or surpass a full month of $5 per week allowance. Further, another of the purposes of the electronic publisher's website is to provide young, novice and unpublished authors, a way to gain exposure as well as to build a readership base for their works. It is contemplated that young or novice authors published on the electronic website may use the opportunity to build a readership as a means to prove the commercial viability of their works and, by this means, interest a traditional commercial publisher in their works. For this reason, the combination of opportunity for compensation and career building are believed to provide young, unpublished and novice creators significant incentives to publish their works electronically.

Since another major purpose of the electronic publication website is to provide opportunities for publication for authors and illustrators of significant merit that are currently being ignored by the commercial publishing industry, the editors will make every effort not to discourage, young, novice or unpublished creators from continuing in their creative endeavors. Thus, if an original work submitted by such an author or illustrator does not quite meet the internal quality control standards of the electronic publisher, the electronic publisher will try to encourage the creator to make the original work available on the free access basis on the web site, rather than on a pay-for-access basis. The electronic publisher will have an internal policy that requires its editors to take into account young authors' and illustrators' ages in devising and applying its editorial publications standards with the benchmark being that at least 30% of the original works published on the website having been created by young authors. For the purposes of its editorial publication standards, young authors and illustrators are defined as persons 18 and younger years of age. The publisher's editorial standards may need to be periodically adjusted to ensure that the 30% benchmark for electronic publication of young author's and illustrator's works is being met on a continual basis. Due to the differences in maturity and experience between children and adult authors, it is believed that a larger than representative number of the free access original works will be those created by younger authors. However, the electronic publisher is committed to publishing as many as possible of the young authors' works that meet its quality standards as pay-for-access works. This is, in part, because young authors are more likely to be encouraged to create new works by the receipt of even very modest sums from the electronic publisher than are adults.

Some creators of original works, particularly prolific ones, may wish to designate a high quality or representative “free example” of their work to provide to the website patrons without charge as a marketing tool to entice website patrons to purchase others of their original works. As it is contemplated that patrons of the website will frequently search for other works by authors that they particularly enjoy, this may be the most effective—and inexpensive—way for individual authors to build a readership through the electronic publication website. For authors that have multiple works approved for publication on a “pay-for-access” basis, the electronic publisher will have a policy of suggesting that such author consider providing a “free sample” of their work to website patrons to generate interest in their other works.

During the submission process, the author is required to provide information concerning themselves and the original work being submitted. These should include at least the following: the creator's name, street address, e-mail address, age, gender, and level of experience in the field of the work (e.g., novice author or illustrator, experienced but unpublished author or illustrator, professional published author or illustrator, etc.). The information collected by the electronic publisher should also include information concerning the original work, such as, the general subject matter of the original work, a brief description of the original work, key words for searching, the reading level of the work, the age group of the target audience, and a suggested portion of the work to publish as a free preview. Optionally, the creator may include a short biography as well as a headshot photograph for electronic publication on the website. As no work will be published by electronic publisher without the creator executing a suitable publishing agreement, the identity of the creator and their address (either e-mail or street address) will be required information so that the electronic publisher can forward a copy of a suitable agreement for execution by the creator. For young authors, that is, minors that have not reached the age of legal majority in the jurisdiction where they reside, it will be necessary for a parent or guardian to execute the publishing agreement along with the minor author or illustrator.

When a decision is made to publish a new work, whether as a pay-for-access or free access publication, a publishing contract is generated (step 70) for each new work. The publishing contract will identify the information from the submission template concerning the author that the electronic publisher intends to make available to the public and will provide the creator with an opportunity to opt out of the default policy to electronically publish such information on the website. The creator is preferably also provided with an opportunity to publish their original work under a pseudonym or anonymously by checking off certain standardized option provisions contained in the standard publishing contract. While in some cases it my be necessary to provide the publishing contract to the creator in electronic format, the electronic publisher's preferred means of delivering the publishing contracts to the creators is by regular hard copy mail. The publication agreement preferably includes a limited number of creator compensation options for selection by the creator, such as allowing viewing and/or reproduction of the work free of charge, for a small sum of money, or in exchange for a donation to a non-profit or charitable organization. The publishing agreement will also include standardized provisions concerning the method of paying the creator, such as, by electronic direct deposit in the creator's bank account. The agreement will include a section for which banking information for direct deposit and/or a street address for receipt of payments by check as well as any hard copy payment statements the creator requests. The creator will also be provided with the option of receiving periodic payment statements either electronically by providing an e-mail address or by regular mail. Thus, in response to the information provided by the creator upon submission of the work, the editorial staff selects the appropriate publication agreement form among a number of standardized agreements. It is contemplated that the terms of the publication agreements for pay-for-access publication, free publication, and for charitable donation publication will be nearly completely standardized and that only one of the agreements selected from the standardized templates will be sent to the creator(s) of a new work. When the creator of a new work returns the executed publishing agreement (step 72) to the electronic publisher, the editorial staff will review the executed agreement (step 73) for completion, consistency and check to see if the creator has attempted to make any material alteration to the agreement. If the executed agreement is complete, consistent with the publishers records concerning the new work, and contains no material alterations, the publisher will remove the on review flag from the inventory database, which will allow public access to the new work. Next, the editorial staff will ensure that the inventory database is updated to include a payment option flag 74, which corresponds to the compensation option selected by the creator. Only the new works which include a compensation option flag are made available to the patrons of the electronic publisher's website. Of course, the compensation option flag may indicate that the work is to be made available to the public in exchange for a charitable donation or payment to compensate the creator, or that the work is being made available free of charge. After the payment option flag is associated with the new work, the work is published electronically (step 76) by making it available to patrons of electronic publisher's website, subject to a cancellation option selected by the creator. All such approved new works which include a payment option flag are maintained in the inventory database. Preferably, at this point, the editorial staff causes autobiographical information concerning the creator, and bibliographic information concerning his creation to also be made available on the website. That information and the new work are maintained in the system memory and are accessible on the website for the public until the electronic publisher makes the editorial decision to remove the work and information.

In situations where a newly submitted work does not meet any of the publication standards for the electronic publisher's website, electronic publisher will send a rejection communication (step 71) to the creator of such rejected works. In the event that the editorial staff believes that there is significant merit to the rejected new work, it may, optionally, suggest editorial revisions to the creator in order to bring the new work up to one or more of the internal quality control standards that have been set by the electronic publisher. Where such a rejection communication is to be sent to a younger or novice creator, the editorial staff will take special care to handle the matter with sufficient sensitivity to avoid discouraging such authors or illustrators from continuing in their creative endeavors. As encouraging additional creative expression is one of the core purposes of the invention, the electronic publisher will set its internal editorial quality standards to meet a benchmark of approving at least 50% and preferably more than 75% of the submitted works for publication on the electronic website. In order to maintain that publication benchmark, editorial staff will maintain an electronic record concerning the number of new works reviewed for publication, the percentage of those works that are approved for publication, the age and experience of the creator of all such works, as well as the percentage actually published upon return of executed publishing agreement from the creator(s).

An additional feature of the electronic publication system and methods of the invention is that it provides an efficient means for charitable or non-profit organizations to raise funds through publication of original creative works on the website of the electronic publisher. Such a method can include providing the creator of a new original work the option to have all of or some portion of the proceeds derived from pay access to the work to be paid directly to a selected charitable or non-profit organization. Accordingly, where an author expresses an interest in such an arrangement, a publishing contract which provides the option of some portion or all of the creator's compensation to be paid directly to a charitable or non-profit organization can be included with instruction concerning selecting that option in a form cover letter. In cases where such a project is coordinated with the public relations personnel for the selected charitable or non-profit organization, the publication of original works for charitable purposes not only has the potential to raise significant funding with little or no expenditure on the part of the charitable or non-profit organization, but also can serve as an efficient marketing tool to drive awareness of the electronic publisher's website.

In another method of the invention, a non-profit fund raising system and method is provided through electronic publication of an original collective creative work. This fund raising system and method of the invention begins with the electronic publisher soliciting collective works from organizations for providing to the public in exchange for a donation to a charitable or non-profit organization. Since promoting philanthropy is another one of the core objects of the invention, the electronic publisher will adopt special editorial policies designed to encourage group works whose publication can benefit legitimate charitable or non-profit organizations. Furthermore, as an added inducement for such organizations to consider electronic publication of a group work as a fund raising option, the electronic publisher will offer enhanced compensation levels in excess of the 50% compensation pass-through offered to “for profit” creators. Preferably, the charitable or non-profit organization will receive at least 75% of funds collected for providing access to such original collective works. The publication process will remain much the same as for individual or “for profit” works in that one or more of the collective work's creators (or the person organizing the project on their behalf) will upload the original creative work to electronic publisher's website for the electronic publisher to consider for potential electronic publication thereon. Next, the electronic publisher will screen the uploaded original, collective work for meeting the publisher's minimum quality standards. Since both encouraging philanthropy and collaborative effort to create original works are core values of the electronic publisher, the editorial standards of the electronic publisher will be adjusted to ensure that the vast majority of such original collective works are accepted for publication. Where an original collective work for charitable publication does not meet the publisher's quality standards, the editors will make every effort to assist the collective authors in elevating the quality of the works to meet its charitable works publication standards. The original, creative collective works that meet the minimum quality standards of the electronic publisher will be approved and designated for generation of a standardized charitable/non-profit organization publication agreement.

The standardized charitable organization publication agreement preferably includes a menu of compensation options offered for the electronic publication of the original, collective work, which includes remittance of a percentage of the funds collected for access to the original collective work to at least one or more designated charitable or non-profit organizations. The agreement shall make clear that the electronic publisher shall retain up to 25% of the fees generated for the project to cover its costs in electronically publishing the work. The agreement will also stipulate that the purchasers of the work will be notified prior to purchase that the electronic publisher is retaining a portion of the proceeds to cover its costs. It is important to note that for collective works, either the charitable organization or the electronic publisher will need to secure the written agreement of each of the contributors to the collective work to the terms of the electronic publication prior to its publication. Upon receipt of the executed publishing agreement (and, in some cases, assignment agreements transferring the author's rights to the charity), the electronic publisher will activate the purchase option on the website server to allow website patrons to access one or more of the electronically published, collective, original works of the collective authors in order for the patron to access the original, collective work, subject to the compensation option selected by one or more of the collective authors. In many cases, the electronic publisher will take additional steps to publicize that works that benefit charitable organizations are available on the website, including providing links to a web page listing the organizations and each of the works benefiting each organization as well as a summary of the money raised to date by each project or for each organization. Next, the electronic publisher then collects the fees or donation from the website patron for access to the collective, original work in accordance with the compensation option selected by the collective authors or, in the event that the collective authors have all assigned their rights in the work to the charitable organization, the recipient it has elected. Then, the electronic publisher remits at least a portion of the fees or donations collected from the website patrons in accordance with the compensation option selected by the collective authors to at least one of the designated charitable or non-profit organizations.

The purchase of such a collective, charitable work will be given the option of printing a receipt to submit to the appropriate tax authorities that reflects the amount of the purchaser's donation. Optionally, the purchasing software on the website may also provide the purchaser/donor to make a donation above and beyond the minimum donation required for access to the original collective work.

In many cases, it is contemplated that such non-profit fund raising projects will be organized and administrated by classroom teachers of school-age children. Such collective works are most likely to be authored and illustrated by the school children and donations are most likely to be solicited from relatives and friends of the school aged authors and illustrators. This model of fund raising has the advantage of requiring little to no capital investment by the school or school teacher and having a built-in audience of friends and relatives of each of the student contributors for a customer base. An added benefit of this fund raising approach is that it's an efficient way to increase the brand awareness concerning the electronic publisher's website in important target markets, i.e., student and teachers, while at the same time assisting them in raising funds to the benefit of the general public. Another added benefit is in encouraging students to acquire valuable life skills—writing, reading, creating artwork, collaborative skill-building, creative thinking—in a more creative, interactive and, perhaps, profitable way for the selected charity/non-profit.

The present invention also provides a method and system for ordering the electronically published works stored in inventory database 36 (or 36a) of flashbook server 22 (or 22a) for website patrons and purchases. The potential purchasers (or patrons) will first direct his web browser 28 (step 80) to the electronic publisher's website. A welcome page 40 on the website will provide the potential purchasers with the information concerning selected publications available for purchased access or free access. The potential purchaser can browse (step 82 or step 87) through information concerning the publications highlighted on the welcome page. Such information will typically include a thumbnail of the title page with illustration for each work, a brief subject matter summary, as well as an indicator as to the intended audience for the work by age and/or reading level. The page will also contain a search field (step 83) so that a patron can search for publications other than those visible on the welcome page by keyword, author, title, subject matter, age group, reading level or any of the other personal or bibliographic material provided by the creator during the submission process detailed above. The search field on the welcome page preferably includes a link to an advanced search page which will allow the patron to conduct a more sophisticated Boolean search for publications of interest as well as provide the opportunity to restrict the Boolean search to specific inventory database fields such as title, subject matter, author or summary. Where detailed information is being collected for a large number of works and creators, it is preferable that the bibliographic and author information be stored in a separate bibliographic and biographic database 44 with suitable links to an author's works stored on the flashbook server 22 or to a relational inventory database.

Once a patron has selected a publication of interest (step 81), the website server 22 will prompt the patron to either view (step 85), pre-view (step 88) or immediately purchase (step 89) a publication without any viewing or pre-viewing. For free access publications, the patron will be allowed immediate access to the work (step 85). For pay-for-access works, it is preferred that at least some portion of the work is offered to the potential purchaser as a free pre-view (step 88). At this point, the potential viewer may choose between the options (step 84) to pre-view the pay-for-access publication, immediately purchase the work (step 89), add the publication to the shopping cart for purchase (step 89) or to continue browsing for additional publications (step 87) by selecting the appropriate web button. If a free access flashbook is selected (step 85) for viewing, the reader is prompted to continue browsing (step 87) after the last page of the flashbook is displayed. If the author of the free access work has other free or pay-for-access works published on the website, it is preferred that the page displayed after the final page of the flashbook suggests to the patron viewing or purchasing such works. Similar prompts may also be given to related subject matter flashbooks. This is accomplished by the search engine 35 automatically running a search sub-routine for related materials in the creator database and inventory database while the patron is viewing the free access publication. The preview web page templates used for previewing each of the publications includes a purchase now button (step 90) which serves to add the previewed publication to the potential purchaser's shopping cart. Of course, at any time during the potential purchaser's visit to the electronic publisher's website, they can elect to return to browsing (step 87) by pressing the return to browsing web button provided on each page of the site. After a publication is added to the shopping cart, the potential purchaser is again prompted to continue browsing or to complete the purchase (step 91) by making payment.

The ordering system of the present invention includes, in one embodiment, the flashbook server system 22 assigning a unique client identifier to each of the client computer systems that connect with the server system 22. The flashbook server system 22 also preferably stores purchaser-specific order information for various potential purchasers. The purchaser-specific order information may have been collected from a previous order for one or more flashbooks placed by the purchaser in customer database 31. The server system maps each client identifier to a purchaser that may use that client system to place an order. The server system may map the client identifiers to the purchaser who last placed an order using that client system. When a purchaser wants to place an order, the purchaser uses a client system to send the request for information describing the work to be ordered along with its client identifier. The server system determines whether the client identifier for that client system is mapped to a purchaser. Also, since the client identifier identifies purchaser-specific order information already stored at the server system, there is less need for such sensitive information to be transmitted repeatedly via the Internet or other communications medium.

When a purchaser elects to purchase a pay-for-access work, this is accomplished by means of shopping cart section of the website. The server system 22 adds summary description of the works being viewed, pre-viewed or browsed and the shopping cart section to each Web page at strategic moments during the patron's visit to the website. Those moments include when a patron first begins publication browsing on the website, after completion of the previewing of a pay-for-access book, when a search result page lists publications after a search is performed, and any other time a patron indicates interest in a specific or group of pay-for-access works. The shopping cart ordering section allows the purchaser to order with a few clicks of a mouse button the described work(s). Once the purchaser clicks the buy now mouse button (step 92), the item is ordered, unless the purchaser then takes some action to modify or cancel the order. After an item is ordered, the e-publisher next confirms receipt (step 94) of the payment. The patron is then allowed access to the flashbook in accordance with the patron's choice (step 96). The purchaser is next prompted (step 99) to access the work in the selected format by either viewing (step 101), printing (step 105), or downloading (step 101). The printing will typically be accomplished by the publisher sending a printable file (step 103) to the patron's client computer. After access is allowed, the e-publisher will terminate the purchaser's access privileges for the purchased work (step 104). A record of the patron's purchase and access option chosen (step 106) is stored in the customer database 33 so they may access it in the future. Lastly, the patron is prompted to submit any unpublished original works (step 107) that the patrons may have authored to the electronic publisher for possible publication.

The ordering section contains an ordering button, purchaser identification subsection, and ordering information subsection. The purchaser information subsection displays enough information so that the purchaser can verify that the server system correctly recognizes the purchaser. To reduce the chances of sensitive information being intercepted, the server system sends only enough information so that the purchaser is confident that the server system correctly identified the purchaser but yet not enough information to be useful to an unscrupulous interceptor. The additional information subsections allow the purchaser to obtain various settings or obtain more information related to the order. If the purchaser wants to verify a previously entered billing address, the purchaser can select the “check billing address” label. In response to this selection, the server system may require the purchaser to perform a “login” so that the identity of the purchaser can be verified before the billing information is viewed or modified. The server system then sends a Web page to the client system for display and possible modification of the billing address. In this way, the transmitting of the sensitive billing address information can be avoided unless requested by the verified purchaser.

When the purchaser selects the ordering button on the shopping cart, the client system 30 sends a message to the server system 22 requesting that the displayed flashbook(s) (A) be ordered. After the server system processes the message, the server system provides to the client system a new Web page that confirms receipt of the order. The confirming Web page contains essentially the same information as the Web page describing the item, except that the ordering button is replaced on the page with a message confirming the order. The order confirmation section confirms that the order has been placed and provides an opportunity for the purchaser to review and change the order.

As briefly mentioned above, FIG. 2 is a block diagram illustrating a second embodiment of the present invention. This embodiment supports the action ordering over the Internet using the World Wide Web. The server system 22a includes a server engine 35a, a client identifier/customer table 31a, various Web pages 40a, a customer database 33a and an order database 32a, and an inventory database 36a. The server engine receives HTTP requests to access Web pages identified by URLs and provides the Web pages to the various client systems. Such an HTTP request may indicate that the purchaser has performed the action to affect an order. The customer database contains customer information for various purchasers or potential purchasers. The customer information includes purchaser-specific order information such as the name of the customer and billing information. However, more detailed bibliographic and author information is stored in bibliographic and biographic database 44a, which is searchable via search engine 42a by key work and advance Boolean searches. The bibliographic data for each work is linked to browsing pages for each work by an author so that the patron can press a more detail web button on the browsing pages to pull up information on each author as well as more detail concerning each work. The order database 32a contains an entry for each order that has not yet been delivered to a purchaser. The inventory database 36a contains a brief description of the various works that may be ordered. The client identifier/customer table 31a contains a mapping from each client identifier, which is a globally unique identifier that uniquely identifies a client system, to the customer last associated with that client system. The client system 26a contains a web browser 28 and its assigned client identifier. The client identifier is stored in a file, referred to as a “cookie.” In one embodiment, the server system assigns and sends the client identifier to the client system once when the client system first interacts with the server system. From then on, the client system includes its client identifier with all messages sent to the server system so that the server system can identify the source of the message. The server and client systems interact by exchanging information via communications link 38, which may include transmission over the Internet.

To enable a customer to place an order, the server system 22 needs to have information about the customer that is sufficient to identify the customer and assure that payment is received. The server system can obtain this information in various ways. First, the server system can ask the customer for the required information. If so, then the server system could prompt the customer using a Web page for the purchaser-specific order information during the placement of a first order by a new customer. If the customer has already placed an initial order, the server system retrieves the client identifier that was sent by the client system. The server system then updates the client identifier/customer table to indicate that the generated client identifier has been associated with that customer. The server system sets a flag indicating that ordering is enabled for that client identifier and that customer combination. That flag is then stored in the client identifier/customer table. The server system supplies a confirming Web page to the client system. The next time a purchaser attempts to order a work, the client system will supply its client identifier to the server system.

The process of generating payments to one or more creators of a work is shown in the flowchart of FIG. 6. Upon verification that E-publisher has received payment (step 110) from a purchaser of a work, an electronic credit for the compensation due the creator(s) is issued to the creator(s) account stored in the creator database 39 for the work purchased. If there is a problem with a credit card or other electronic payment pledged to be paid by a patron, the purchaser is immediately notified of the problem (step 111) and customer access privileges are immediately cut off until the issue is resolved (step 113) to the publisher's satisfaction. Then, the order processing server 33 queries the creator database for the compensation option chosen by the creator for the work for which payment is received. It then calculates the credit due (step 114) to the creator(s) account(s) and sends an electronic credit signal (step 115) to store an electronic credit in the creator database for each of the creators of a work. However, in the case of a charitable donation for access to the work, an electronic credit is sent to a charitable organization database 43, rather than to the creator of a work. It is preferred that creators (as well as any charitable organizations) are paid periodically on an agreed schedule set forth in each creator's publication agreement. Accordingly, the financial database 41 incorporated programmed payment rules, which cause the periodic payments process to be initiated by first sending a signal to the creator database to aggregate (step 116) all unpaid credits for each creator (or charitable organization) in the creator database 39 and charitable database 43, respectively. Next, server 22 sends a signal(s) to the financial database to save the calculated information concerning aggregated sums due the creator or charitable organization during the time period in question. The preferred time period for payment for the systems and methods of the invention is quarterly. Next, the server generates a signal(s) to commence payment for each creator/charitable organization to which payment is due during the time period in question. In most cases, the creator/charitable organization will provide the electronic publisher with direct deposit information so that the compensation payments are made directly into the account specified by the creator/charitable organization. Preferably, where direct deposit is utilized for payment, a separate electronic message is sent to the creator/charitable organization confirming the payment. Where direct deposit is not available, the financial database 41 will generate paper check payments to be sent by regular mail. In either case, the server causes the financial database to record the new payments made to each creator/charitable organization and the server generates a payment statement (step 118) from the stored information. A statement is then sent (step 122) either electronically or by regular mail to each of the authors/charitable organizations showing the number of purchases of each work, the compensation formula applied, and the amount of compensation paid. Preferably, the statement also includes historical payment data such as year-to-date and life-to-date payments made for each work of the contributor/charitable organization.

Other modifications or variations of the present invention are possible in light of the above teachings of the invention. The invention may be practiced in other forms than described herein and be covered by the scope of the claims for this invention.

1. An electronic publishing method comprising the steps of:
soliciting original works for electronic publication in book form through a world wide website operated by an electronic publisher;
uploading by the creator an original work to the website for potential electronic publication thereon by the electronic publisher;
screening by the electronic publisher the uploaded original work for compliance with minimum internal quality standards;
approving by the electronic publisher each of the uploaded original works for electronic publication that meet the minimum internal quality standards;
delivering a publication contract directed to the original work from the electronic publisher to the creator for execution;
selecting by the creator one of a limited number of compensation options offered by the electronic publisher for electronic publication of the original work;
electronically publishing the approved original work in book form subject to the compensation option selected by the creator; and,
providing means for patrons to access the original work in book form, subject to the compensation option selected by the author.

2. A method in accordance with claim 1 comprising the further steps of collecting funds from the patrons in accordance with the compensation option selected by the creator for access to the original work.

3. A method in accordance with claim 1 comprising the further steps of remitting a portion of any funds collected from the patron during a given period of time in accordance with the compensation option selected by the creator of the work prior to electronic publication.

4. A method in accordance with claim 1 comprising the further steps of providing a searchable database for indexing and allowing patrons to search and select suitable electronically published original works from an indexing database of original works that are made available to the patron.

5. A method in accordance with claim 1 wherein the step of selecting by the creator one of a limited number of compensation options offered by the electronic publisher for electronic publication of the contribution includes an option for the patrons to provide a donation to a non-profit organization of the creator's choice in exchange for access to creator's original work.

6. A method in accordance with claim 1 wherein the step of selecting by the creator one of a limited number of compensation options offered by the electronic publisher for electronic publication of the original work includes the option to provide the access to the original work to patrons free of charge for viewing.

7. A method in accordance with claim 1 wherein the step of selecting by the creator one of a limited number of compensation options offered by the electronic publisher for electronic publication of the contribution includes the option of providing at least one of the creator's works to patrons free of charge for viewing on the website and to make one or more of creator's other works available for purchase by patrons.

8. A method in accordance with claim 1 wherein the step of providing means for patron access to the original creative works include at least means for the patron to print the original work on a printer associated with the patron's computer, the patron to view the original work on a display associated with the patron's computer, and the patron to download the original work to a digital storage media associated with the patron's computer.

9. A method in accordance with claim 1 comprising the further steps of providing an electronic communication to selected groups of individuals informing them that a particular creator's new work has been electronically published.

10. An electronic publication method which provides financial incentives paid by an electronic publisher for unpublished authors to create creative works comprising:
soliciting from unpublished authors original creative works for electronic publication in book form through a website operated by an electronic publisher;
selecting a majority of the original creative works submitted by the unpublished authors for electronic publication on the website in book form;
providing the unpublished authors with a limited number of compensation options for electronic publication of the original works;
electronically publishing the original work on the website subject to the compensation option selected by the unpublished author;
providing means for website patrons to select one or more of the electronically published original works of the unpublished authors in order to access the work;
collecting a fee from website patrons in accordance with the compensation option selected by the unpublished author for each work; and
remitting the portion of the funds collected from the website patrons in accordance with the compensation option selected by each of the unpublished author.

11. An electronic publication method in accordance with claim 10 wherein the step of providing the unpublished authors with a limited number of compensation options includes offering the unpublished author at least 50% of the funds collected from patrons of the website for accessing the unpublished author's original work.

12. An electronic publication method in accordance with claim 10 wherein the step of providing the unpublished authors with a limited number of compensation options includes defining the fees to be assessed a patron for accessing the unpublished author's original work on the website.

13. An electronic publication method in accordance with claim 10 wherein the step of selecting a majority of the original creative works submitted by the unpublished authors for electronic publication, includes the electronic publisher defining a set of internal quality control standards subject to young unpublished authors that ensures the percentage of young unpublished authors selected by the electronic publisher is not less than about 30% of the original works chosen for electronic publication on the website.

14. An electronic publication method in accordance with claim 10 comprising the further step of providing an electronic communication to a group of individuals selected by the unpublished author informing them that the unpublished author's original work has been electronically published on the website.

15. An electronic publication method in accordance with claim 14 wherein the step of providing a limited number of compensation options to the unpublished author includes the option for an unpublished author to make access to the original creative work free of charge and wherein the step of providing an electronic communication to a group of individuals selected by the unpublished author includes sending notification that the unpublished author's work has been electronically published on the website to at least a group of relatives of the unpublished author.

16. A method of non-profit fund raising via electronic publication of an original collective creative work comprising the steps of:
soliciting original, collective creative works for electronic publication in book form through a website operated by an electronic publisher in order to generate funds for at least one charitable or non-profit organization selected by one or more of the collective authors;
uploading by one or more of the collective authors the original creative work to the website for potential electronic publication thereon by the electronic publisher;
screening by the electronic publisher of the uploaded original, collective work for meeting minimum quality standards of the electronic publisher;
approving by the electronic publisher those uploaded original, collective works that meet the minimum quality standards of the electronic publisher;
providing the collective authors with a menu of compensation options offered by the electronic publisher for electronic publication of the original collective work, which include remittance of a percentage of the funds collected for access to the collective work to at least one designated charitable or non-profit organization;
providing means for website patrons to access one or more of the electronically published, collective, original works of the collective authors in order to access the original, collective work, subject to the compensation option selected by one or more of the collective authors;
collecting the fees from website patrons for access to the collective, original work in accordance with the compensation option selected by the collective authors; and
remitting at least a portion of the fees collected from the website patrons in accordance with the compensation option selected by the collective authors to at least one designated charitable or non-profit organization.

17. A method in accordance with claim 15 comprising the further steps of providing an electronic communication to a group of individuals selected by the collective authors informing the individuals that the collective authors' original, collective work has been electronically published on the website and that donations for accessing the original, collective work will benefit at least one designated charitable or non-profit organization.

18. A method in accordance with claim 15 wherein the step of collecting the fees from website patrons for access to the original, collective work includes informing the patrons that the donation of funds exceeding the minimum fee for accessing the original, collective work will solely benefit at least one designated charitable or non-profit organization.

19. A method in accordance with claim 15 wherein at least some of the collective authors are school-aged children and wherein the electronic communication group of individuals include a group of relatives of at least some of the school aged children.

20. An electronic publication method for publication of original creative works, comprising:
soliciting original creative works from independent creators for electronic publication in flashbook form through a website operated by an electronic publisher;
requiring submission of the original creative works with text and images contained in electronic files for conversion into opposing pairs of flashbook pages;
providing the independent creators of the submitted original creative works with a limited menu of compensation options for electronic publication of the original works;
electronically publishing the original work in flashbook form with the text and images displayed in opposing pairs of pages subject to the compensation option selected by the independent creators from the limited menu of compensation options;
providing means for patrons to select one or more of the electronically published original works in order to access the original creative works;
collecting a fee from patrons in accordance with the compensation option selected by the independent creators for each of the works; and
remitting the portion of the funds collected from the patrons in accordance with the compensation option selected by each of the independent creators of each of the works.
